(19) United States
(12) Patent Application Publication
(10) Pub. No.: US 2010/0235745 A1
(43) Pub. Date: Sep. 16, 2010

(54) ACCESSIBILITY SYSTEM FOR CONSUMER DEVICES

(75) Inventor: Peter Shintani, San Diego, CA (US)

Correspondence Address: RADER FISHMAN & GRAUER PLLC, LION BUILDING, 1233 20TH STREET N.W., SUITE 501, WASHINGTON, DC, 20036, US

(73) Assignees: SONY CORPORATION, Tokyo (JP); SONY ELECTRONICS INC., Parkridge, NJ (US)

(21) Appl. No.: 12/401,433

(22) Filed: Mar. 10, 2009

(51) Int. Cl. G06F 3/00; H04N 5/445

(52) U.S. Cl. 715/719; 725/37

(57) ABSTRACT

An electronic device includes a number of features for which settings can be adjusted by a user. The device includes a user interface through which the user can adjust the settings; a standard operating mode in which settings for all of the features are available through the user interface, when activated; and an increased accessibility operating mode in which settings for the features are presented differently in the user interface, when activated, than in the standard operating mode.

### BACKGROUND

As the demand for consumer electronic devices grows, products such as television sets, Digital Video Disc (“DVD”) players, cable and satellite set top receivers, Digital Video Recorders (“DVR's”) and other electronic devices are being designed and manufactured with ever increasing features and functionality. While some users who are comfortable with electronics and technical material are readily are able to take full advantage of the many features on these devices, other users become overwhelmed with the complexity involved.

Many consumer electronic devices are equipped with on-screen display menus. These menus allow the user to navigate among and adjust the various settings on the device to fit their preferences. As more features are added and functionality of the electronic device increases, so does the complexity of the on-screen menu. Though some efforts have been made to simplify these on-screen menus, some users may still get lost in the multitude of options available to them. Some users do not even attempt to use many advanced features and do not like to have to dig through the menu system to find the simple features they do want to adjust.

Many electronic devices include a quick start guide intended to orient users to at least the most important features of the device in a short period of time. The quick start guide may either be printed on paper and sold with the device or may be part of the on-screen menu. While a typical quick start guide may be useful to some users, many users would prefer not to bother with learning about all the new or advanced features that with which their device is equipped. Instead, they would prefer to just use the simple features they are comfortable with and not worry about the more complicated features. There are many advanced features that, while useful to some users, are overwhelmingly complex for others. These advanced features may include surround sound settings or organizing multiple channels/sources on the same screen.

Manufacturers could consider providing different models of a device; some that have advanced features desired by advanced users and versions with more simple features. However, it would be expensive for manufactures to design and manufacture multiple models of a device to fit the specific needs of the various people in their market. It would be ideal if the manufacturer could make one model of a device capable of adapting to the customer's needs.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustration of a television with an on-screen menu display according to principles described herein.

FIG. 2 is an illustration of an electronic device connected to a television as another example of a device according to principles described herein.

FIG. 3a is an illustration of an exemplary on-screen menu for a device in a standard operating mode, according to one embodiment of the principles described herein.

FIG. 3b is an illustration of an exemplary on-screen menu for a device operating in an increased accessibility mode, according to one embodiment of the principles described herein.

FIG. 4 is a comparison between two different remote control units, one for standard mode and the other for increased accessibility mode, according to one embodiment of the principles described herein.

FIG. 5a is an illustration of an exemplary electronic programming guide (“EPG”) in increased accessibility mode, according to one embodiment of the principles described herein.

FIG. 5b is a flow diagram of an exemplary submenu flow to set the EPG mode, according to one embodiment of the principles described herein.

FIG. 6a is an illustration of a surround sound system setting in which an increased accessibility mode could make hearing easier for some users, according to one embodiment of the principles described herein.

FIG. 6b is a comparison of two bar graphs comparing the volume of the center speaker and the surround sound speakers.

FIG. 7 is a flowchart illustrating a method of making an electronic device that has a number of features for which settings can be adjusted by a user with a user interface according to one embodiment of principles described herein.

Throughout the drawings, identical reference numbers designate similar, but not necessarily identical, elements.

### DETAILED DESCRIPTION

The present specification describes an electronic device and methods of making and operating the same, where the device has bother a standard mode and an increased accessibility mode. In the standard mode, all the features of the device are available to the user, any available settings may be adjusted and the user interface of the device includes all such available features and settings. In the increased accessibility modes, the user interface and any menu of features and settings is simplified and/or reorganized to make it easier for less sophisticated users to access and use the more basic features of the device. The user can then select whether the device will operate in standard or increased accessibility mode.

There may also be different default settings associated with the two different modes. For example, during standard mode, a nominal set of default settings are implemented, and the on-screen menu display includes the access to all settings for all available features of the device. When the user changes operation to the increased accessibility mode, default settings for a variety of features on the device may also be changed, in particular where such a change makes the device easier to operate for a less sophisticated user. In other words, in the increased accessibility mode, the default settings are changed to make the device easier to operate for those who wish to have a simpler user interaction with the device.

One example of the difference between the standard and increased accessibility modes is that, in the increased accessibility mode, certain menu items which tend to be advanced or complex are omitted from the on-screen menu system and simply operate, if at all, on default settings. This will leave only commonly used and simply features in the reduced menu. Examples of commonly used and simply features may include volume control, channel selection, an electronic program guide and others. By allowing the user to switch between standard and increased accessibility modes, users will be able to set their television or other electronic device to cater to their usage style.

As will be appreciated by those skilled in the art, the principles described herein may be built into any of a wide variety of consumer electronic devices. With principles described herein, manufacturers of consumer electronic devices will be able to design and manufacture a single model of each device that is more readily adaptable to the various needs of individual customers within the market. The same model is able to be used and enjoyed by those who are technically inclined and will take full advantage of all the features available to them as well those who prefer to have a simpler device.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

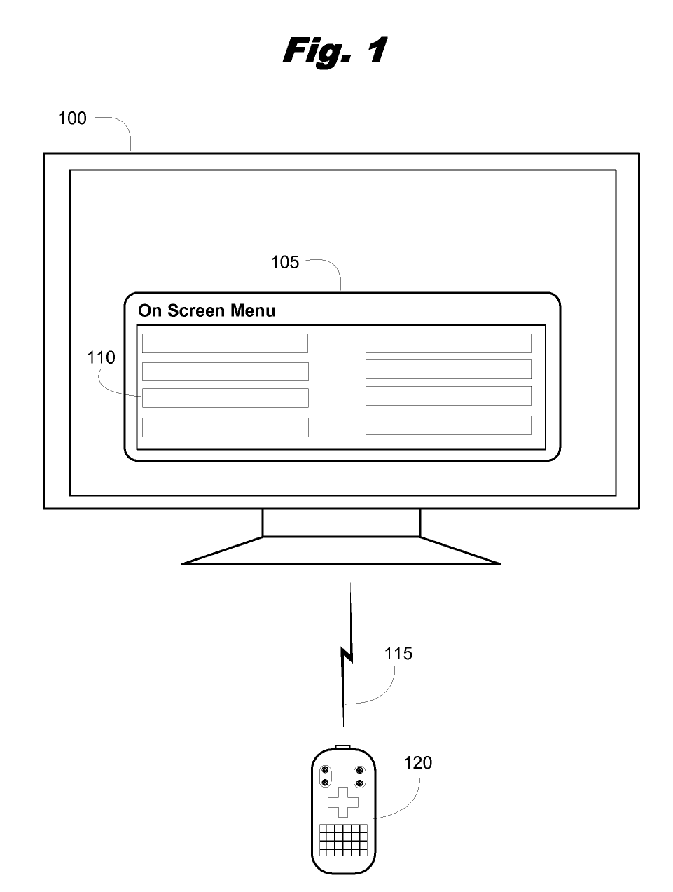

FIG. 1 is an illustration of an exemplary electronic device according to principles described herein. A television set (100) has an on-screen display menu (105). The on-screen menu consists of many different settings (110) that can be adjusted for various features of the television set. The on-screen menu is typically accessed and controlled using a remote control device (120). Modern remote control devices typically use an infrared communication system (115) to communicate. Through the use of the on-screen menu, the user can adjust various settings including, for example, display parameters, sound parameters, font settings, language setting, closed caption settings, and many other settings with which the television set may be equipped.

As described above, some users may find it difficult to access and control the specific common features they wish to adjust among so many options. Consequently, as will be described in more detail below, the television set (100) provides both a standard operating mode and an increased accessibility mode. When in the increased accessibility mode, the number of options in the on-screen menu may be significantly reduced to only the most commonly used settings. Additionally, the listing of options in the on-screen menu may be reorganized to place the settings in the order corresponding to how frequently each is adjusted by the average user. In some embodiments, the device may track the actual user's access to specific features and reorder the features in the menu according to how frequently the specific user of that device has actually accessed each feature previously.

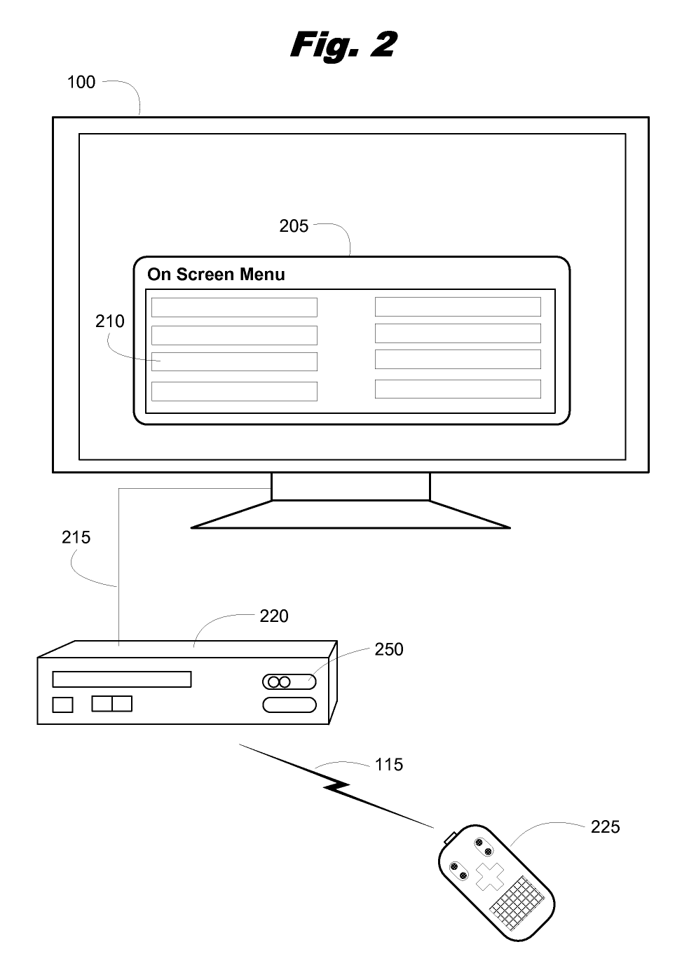

FIG. 2 is an illustration another embodiment in which the device having both a standard operating mode and an increased accessibility mode is a connected to a television set, monitor or other display device (100). The device (220) with both the standard operating mode and increased accessibility mode may be, for example, a set-top box, a digital video disc (“DVD”) player or a Digital Video Recorder (“DVR”). The device (220) is connected to a television set (100) through a cable (215). There may also be other methods of connecting an electronic device (220) to the television (100).

As in the case of some electronic devices, such as the device (220), no display is part of the device. However, the device (220) may still have an on-screen display menu (205) that is used to adjust various settings (210) for features that are included with the electronic device (220). However, lacking its own display, the device (220) is connected to a display device (100) in order to access the on-screen menu. As before, the electronic device (220) and its on-screen menus are typically operated by a remote control device (225). Like the remote described above, this remote control device (225) typically use an infrared communication system (115) to send commands to the electronic device.

As mentioned above, the user has a choice to set the display device (100) and/or other associated electronic device (220) to either a standard operating mode or an increased accessibility mode. In the increased accessibility mode, for example, the font size for wording in the on-screen display menu may be enlarged, the on-screen menu may omit more complicated or less frequently used features or settings, the sound settings may be adjusted to emphasis the center channel to make dialogue more readily audible for some users, adjusting the appearance of and ease of use of the electronic program guide (“EPG”), and moving the more commonly used features to the top level of the menu system.

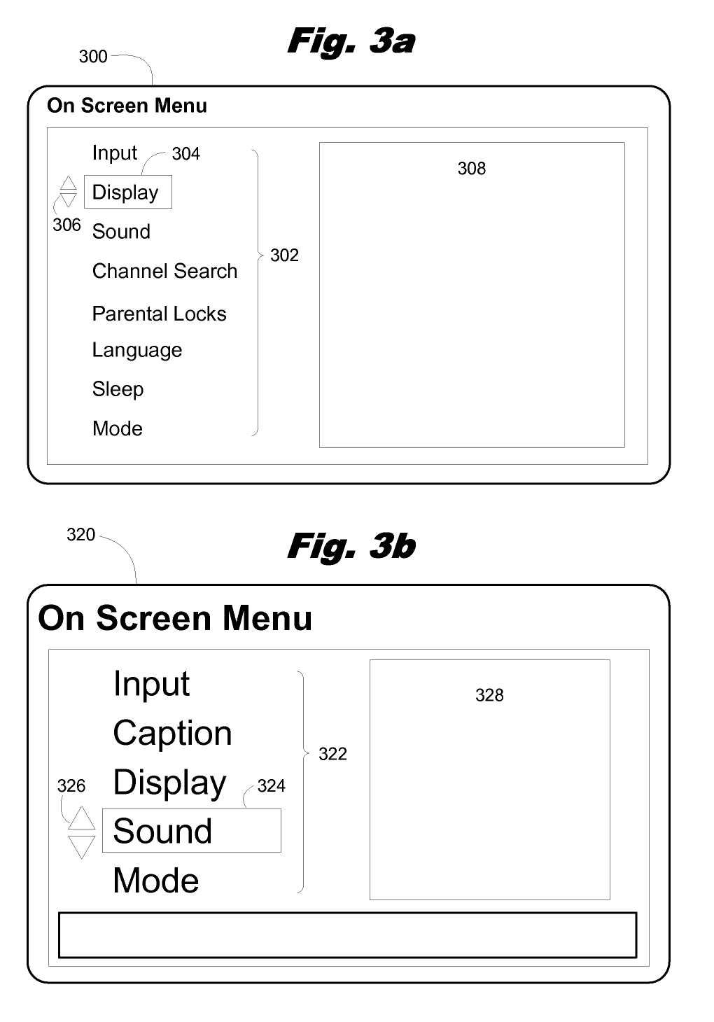

FIGS. 3a and 3b are a comparison between two exemplary on-screen menu systems for an electronic device. The user interface illustrated in FIG. 3a is in a standard operating mode. The user interface illustrated in FIG. 3b is in an increased accessibility mode.

As shown in FIG. 3a, a main menu includes a list of submenu options (302) such as display, sound, and language settings through which the user can scroll. A cursor (304) can be moved through the list of submenu options (302) and indicates when submenu option will be activated if a selection is made. The cursor (304) may be a highlight or box as shown in FIG. 3a. Arrows (306) on the side (306) may indicate the ability to move the cursor (304) up or down to hover over a different submenu title.

To the right of the submenu titles (302) may be a preview box (308) displaying information about the functionality of the submenu indicated by the location of the cursor (304). For example, if the display submenu is indicated, the preview box (308) could display information about the current display settings and list what types of settings could be changed under the display submenu.

When a user selects one of the submenu titles (322), the on-screen menu will typically switch to a submenu which will show a list of settings that can be adjusted under the submenu. Their may even be more submenu options within a submenu, adding to the complexity of navigating through the system. As noted above, many users do not like to have to dig through the many available features to find those that are commonly used.

In one embodiment, there may be a submenu title called mode. By accessing this submenu, the user accesses an option to operate the device in either standard or increased accessibility mode as described herein. The user may be advised of this feature prominently in a printed quick start guide or when first powering up or configuring the device so as to make the device as user-friendly as possible.

FIG. 3b is illustrates an exemplary on-screen display menu (320) for a device that has been switched to increased accessibility mode. In the illustrated example, the font is bigger, thus making it easier to read. There are also fewer submenu titles (322) to choose from. Like in the standard mode, the submenu title (322) which is indicated by the cursor (324) can be highlighted or boxed, and arrows (326) indicate that the user can scroll up or down through the submenu title list. Again, a preview box (328) is included to display information relating to the current submenu title (322) which is being highlighted or boxed (324).

In the illustrated example the caption menu may be located at or near the top of the submenu title list. In the standard mode, the closed caption settings are likely under a submenu title such as language. In the increased accessibility mode, they can be placed in the main submenu list, making it easier to find and allowing the user to adjust those settings more easily as desired.

In various embodiments, the entire menu structure of the on-screen menu system can be rearranged so as to allow the more commonly used features easier access, for example, by placing the submenu or option for the most commonly used settings at or near the top of any submenu listing. In some embodiment, the device may track the actual user's access to specific features and reorder the features in the menu according to how frequently the specific user of that device has actually accessed each feature previously.

In addition, several features could be omitted from the on-screen menu and submenus in the increased accessibility mode. For example, the sound submenu may only have one or two different settings that can be changed when in increased accessibility mode as opposed to ten or twenty settings including more submenu levels in the standard operating mode. Those skilled in the design of user interface systems are able to determine any number of improved menu structures for an increased accessibility mode.

There may be a variety of methods used to switch between the standard mode and the increased accessibility mode. In one embodiment, the electronic device would come shipped from the factory in the standard mode. The user may then adjust the mode of operation using the on-screen menu. Some electronic devices require the user to go through a setup or configuration process when the device is first used. In such an environment, the user may be prompted using an on-screen display to select the mode in which they would like their device to operate. The user may then select either the standard operating mode or the increased accessibility mode.

Whichever mode the user chooses need not be permanent. The user will be able to switch between the standard mode and increased accessibility mode any time the user desires.

There are a variety of others ways a user could switch between the two modes described herein. In one embodiment, the device could come equipped with a mechanical switch or button (250, FIG. 2) that will allow the user to switch between a standard operating mode and an increased accessibility mode. This switch could be placed in the front of the device near the rest of the controls or on the sides or back of the device where it is relatively isolated from the rest of the controls. The device could also include some display method indicating what mode the device is in. This display could either a light emitting diode (“LED”) or a small liquid crystal display (“LCD”) screen.

In other embodiments, the user could switch between a standard operating mode and an increased accessibility mode through the on-screen display menu. As mentioned above, this option could be under a mode submenu. In one embodiment, the setting to switch between the two modes could be in a deeper submenu level.

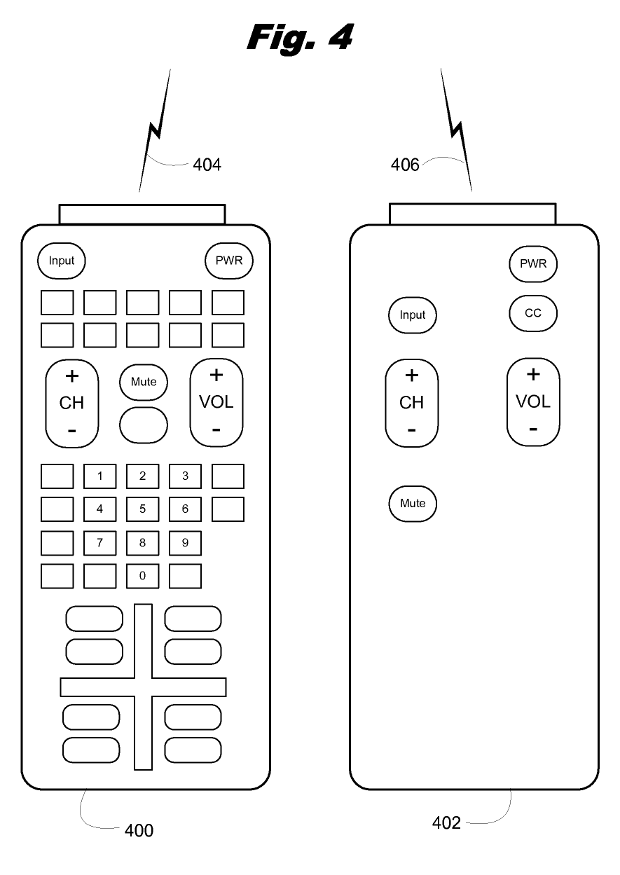

In one embodiment, the mode of the electronic device can be switched simply by using a different remote control. For example a television could come with two remotes, one with standard controls and the other with increased accessibility controls. FIG. 4 is an illustration of two different exemplary remote control units for a television which can operate in either standard or increased accessibility modes.

The remote on the left is the standard remote (400). The standard remote (400) comes with controls for the standard usage such as channel, volume, power, input and mute. It also comes with a myriad of other controls for the many features which are available to the user who wishes to use more advanced features.

The remote on the right is a simplified remote control (402) for operating in increased accessibility mode. It includes fewer controls than the standard remote (400). The simplified remote control (402) may includes only the most commonly used buttons, for example, the power, input, channel, volume, mute, and caption buttons. The exact buttons which are on the increased accessibility remote (402) are not necessarily limited to, or inclusive of, the ones shown in the figure. The figure shows only one embodiment of the simplified remote for operating the increased accessibility mode.

The electronic device controlled by the remotes (400, 402), for example, a television, can be programmed to switch to whatever mode corresponds with the associated remote from which control signals are being received. If the standard remote control device (400) is being used, the controlled device will switch over to a standard operating mode if it was previously operating in an increased accessibility mode. If the device was already operating in standard mode, no change would be necessary upon use of the standard remote control device (400).

If the increased accessibility remote control device (402) is being used, the controlled device will switch over to an increased accessibility mode if it was previously operating in a standard mode. If the device was already operating in an increased accessibility mode, no change would be necessary upon use of the simplified remote control device.

The controlled device distinguishes between which of the two remotes (400, 402) is being used. One possible method for this would be to have each remote encode its control signal in a different way. For example, the standard remote (400) could send out an infrared signal (404) coded with a first identifier or protocol and the increased accessibility remote (402) could send out an infrared signal (406) coded with a different identifier or protocol.

The signal receiver on the controlled device is programmed to distinguish from which remote the signal is coming. For example, based on an electronic identifier or coding protocol, the signal receiver on the controlled device will adjust the operating mode of the controlled device accordingly.

A further aspect of the invention would be to have a simpler electronic program guide (“EPG”) when operating in an increased accessibility mode. Television sets or satellite/cable set top receiver boxes often come equipped with an EPG. The EPG is an on-screen display which allows the user to view a TV broadcast schedule. The user can use the remote control device or buttons on the device itself to scroll through the EPG and see what shows are being broadcast at the present time. A user may also be allowed to scroll to the right and view future broadcast schedules.

In an increased accessibility mode, for example, the EPG can be configured to have a bigger font and not contain various advanced features which are characteristic for some EPG's. Advanced features for an EPG may include information about a particular broadcast or allow the user to set a reminder for when a future broadcast is about to occur.

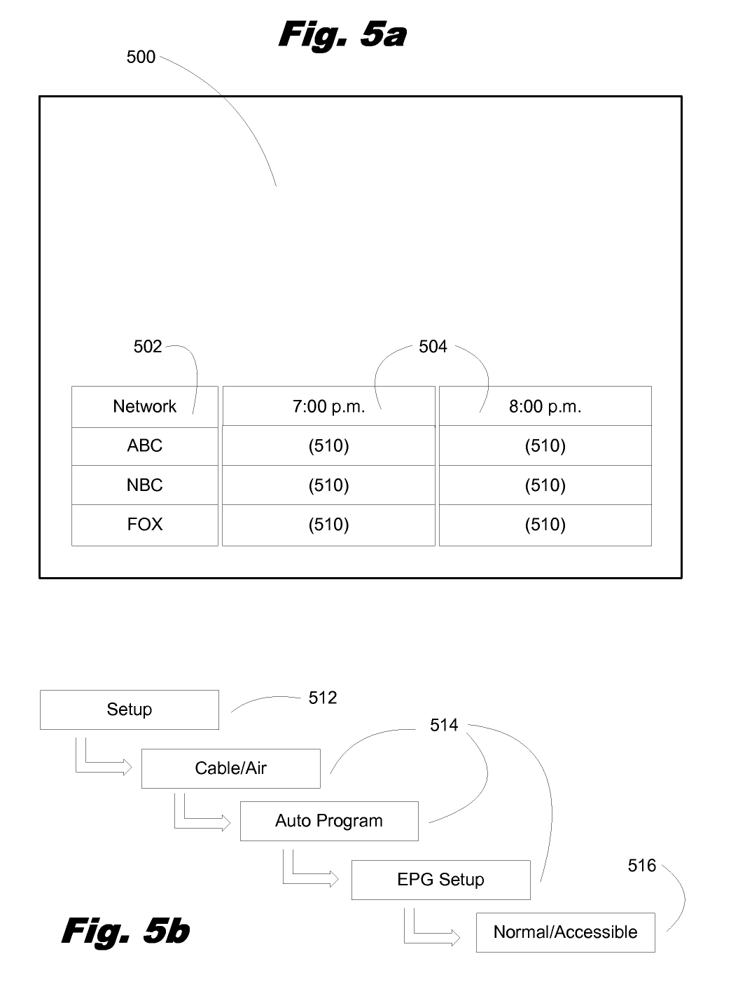

FIG. 5a is an exemplary illustration of an EPG in increased accessibility mode. In the illustrated example, the EPG menu is typically displayed on the bottom half of the display. In a typical EPG, the current channel tuned can still be viewed behind the EPG menu at the bottom. Some EPG's may put the current channel in a box in the upper left or right corner.

On the illustrated EPG system, the left column shows the channel name or network (502). The rest of the columns (504) are assigned a time window. The various programming available (510) is displayed associated with broadcast time and channel.

As mentioned above, several features may be overwhelmingly complex for some users. Features such as having the option of displaying info about the various broadcasts or scrolling forward and back in time to see what broadcasts will be on at different times may be too complex for users who wish to operate in increased accessibility mode. Thus, when operating in the increased accessibility mode, all those excess and unnecessary features may be eliminated from the EPG system.

In some cases, a user may want specific features of their electronic device to operate in an increased accessibility mode while the rest of the features operate in a standard operating mode. For example, a user may want to set the EPG to an increased accessibility mode while the rest of the features such as the surround sound and on-screen menu remain unchanged. Consequently, the present specification includes being able to set individual features of an electronic device to operate in an increased accessibility mode without affecting the standard operation of any other features.

For example, FIG. 5b illustrates one embodiment in which a user can navigate through the menu structure to set a specific feature of their device to run in an increased accessibility mode. In the illustrated example, the user would start with the main submenu selection “Setup” (512) and then continue making additional submenu selections (514) to reach an “EPG Setup” menu. In this submenu, the EPG can be switched from a standard mode to an increased accessibility mode (516).

Another feature that could be implemented when the device is in an increased accessibility mode is to have the device turn off after a set time of not using it. Some users tend to wander off and leave their device on. This can consume unnecessary power or become a safety hazard. For example, a television could be set to turn off after an hour or two of inactivity.

Some users will be watching a show for that long of a period and so an alternative means of determining if someone is watching may be used. Another embodiment would be to have a motion detector to determine whether someone is still in the room watching the television or not. Thus, an increased accessibility mode may, in some embodiments, include a system which will be able to turn an electronic device off after a period of inactivity by determining if there actually is someone using the device or not.

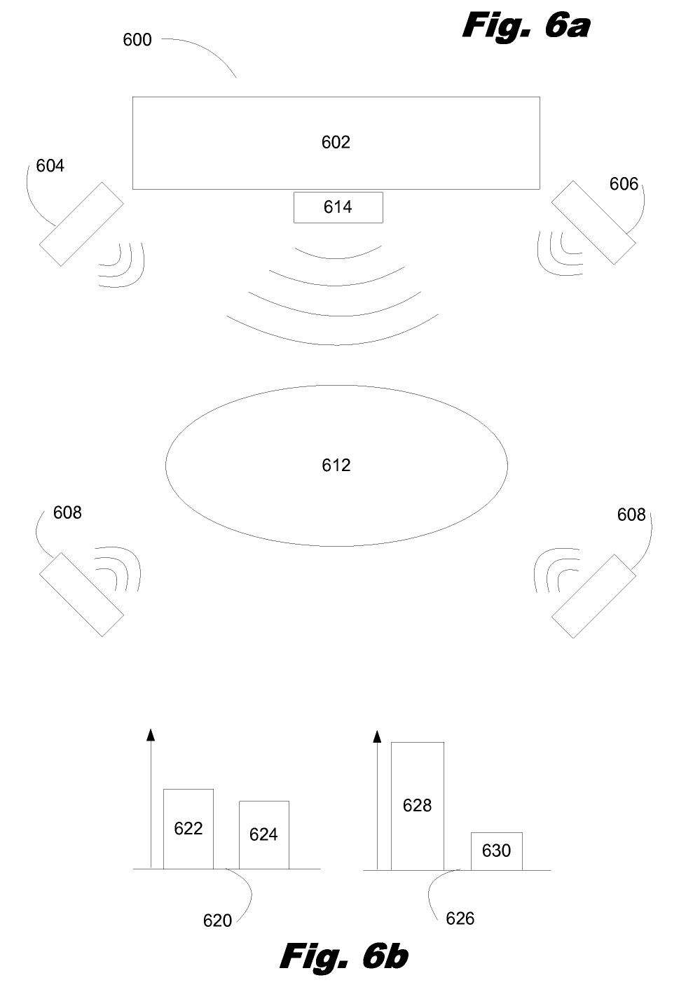

Some users who have difficulty hearing may desire an increased accessibility mode that specifically addresses sound issues. FIGS. 6a and 6b are used to illustrate how a surround sound system for an electronic device may be adjusted depending on whether the device is operating in a standard or increased accessibility mode. For example, those hard of hearing may sometimes find it difficult to hear the dialog, which is usually output by a central forward speaker, when there are also sound effects coming from side speakers of the surround sound system.

FIG. 6a is an illustration of a surround sound system (600). In the figure, the user generally sits in the area (612) in front of the television (602). There are several speakers projecting sound at the viewer. Typically, there is a front left speaker (604), a front right speaker (606), back speakers (608), and a center speaker (614). Surround sound systems vary in the amount of channels they use. For example, some surround sound systems have two separate channels for the two back speakers. Other surround sound systems have only one channel for both back speakers. As indicated, in a standard surround sound system, the center speaker (614) typically outputs the dialog.

In some embodiments of the principles described herein, the increased accessibility mode may include a setting under which the volume of the center speaker volume is increased relative to the volume of sounds coming from the other speakers (604,606,608). FIG. 6b shows a comparison of two different bar graphs representing the volume of the center speaker (614) and the surround sound speakers (604,606,608). The graph on the left (620) is a comparison of the values when the system is in standard mode. The bar on the left (622) represents the volume of the center speaker (612) and the right bar (624) represents the volume of the other speakers. It can be seen that the center speaker volume is only slightly higher than the volume of the rest of the speakers.

The right graph (626) is a comparison of the center speaker volume and the surround sound speaker volume when the system is in increased accessibility mode. Again, the bar on the left (628) represents the volume of the center speaker (614) and the bar on the right (630) represents the volume of the surround sound speakers (604,606,608). It can be seen that the center speaker volume (628) is significantly higher than the surround sound speaker volume (630). This will be beneficial to those who may be hearing impaired as the dialog will be easier to distinguish over other surround sound effects which may be coming from the surround sound speakers (604,606,608).

These graphs do not necessarily represent the exact ratio between the center speaker and the surround sound speakers. Those skilled in the relevant art are able to develop an appropriate ratio for various embodiments. In one embodiment, the surround sound system can be simply disabled in the increased accessibility mode. All audio channels will then come from the center speaker (614).

Another feature which could be changed when the device is set to an increased accessibility mode would be the audio response. For those hard of hearing, certain audio sounds created by certain frequencies may be more difficult to hear than others. For example, high frequency sounds such as the “t” sound are usually not heard by those who have difficulty hearing. An electronic device can be designed so that the audio system can adjust the audio response allowing those who may be hard of hearing to better hear the dialog. Those skilled in the relevant art are able to tailor the audio response so that it is best suits the needs of those who are hard of hearing.

Throughout this description, several different features which could be adjusted when the user is in accessibility mode have been mentioned. The invention is not limited to these specific settings. A product embodying the principles described herein may contain any combination of specific settings to be adjusted as the device is switched between a standard mode and an increased accessibility mode.

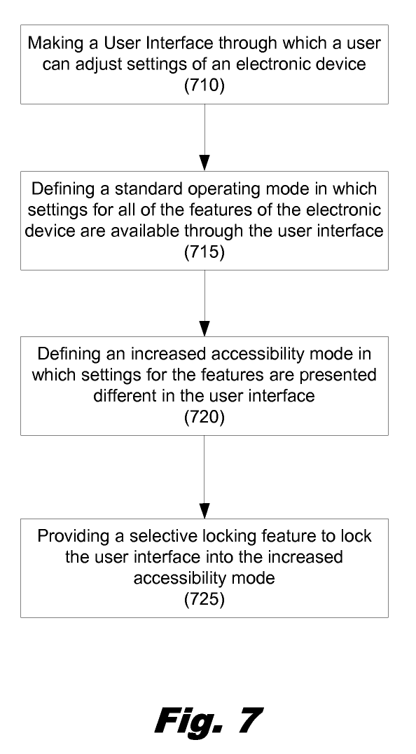

In summary, FIG. 7 is a flowchart illustrating a method of making an electronic device that has a number of features for which settings can be adjusted by a user with a user interface according to one embodiment of principles described herein. As shown in FIG. 7, the method begins with making a user interface through which the user can adjust the various settings of the electronic device (step 710).

Next, the method includes defining a standard operating mode in which settings for all of the features are available through the user interface, when activated (step 715). However, as noted herein, some users may have access to all the available features to be too complicated and unwieldy.

Consequently, the method also includes defining an increased accessibility operating mode in which settings for the features are presented differently in the user interface, when activated, than in the standard operating mode (step 720). As described herein, this different presentation may include a different ordering of the adjustable settings or a reduction in the number of settings available.

In some embodiments, the method may also include providing a selective locking feature to lock the user interface into the increased accessibility mode, once activated. This may include an on-screen menu selection item that locks the user interface into the increased accessibility mode. In some embodiments, a password or other identifier may be required to unlock the user interface and return to the standard operating mode

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. An electronic device comprising a number of features for which settings can be adjusted by a user, said device comprising:
a user interface through which said user can adjust said settings;
a standard operating mode in which settings for all of said features are available through said user interface, when activated; and
an increased accessibility operating mode in which settings for said features are presented differently in said user interface, when activated, than in said standard operating mode.

2. The device of claim 1, wherein said increased accessibility mode provides access to settings for less than all of said features in said user interface, when activated.

3. The device of claim 1, wherein said increased accessibility mode reorders access to settings for said features as presented in said standard operating mode.

4. The device of claim 3, wherein said device tracks which settings are most frequently adjusted by a user and reorders a listing of said settings in said user interface accordingly.

5. The device of claim 1, wherein said user interface comprises an on-screen display.

6. The device of claim 1, wherein said electronic device comprises any of a television set, video player or video recorder.

7. The device of claim 1, wherein said user interface further comprises a lock for selectively locking said user interface into said increased accessibility mode, once activated.

8. The device of claim 1, wherein said device comprises a remote control unit.

9. The device of claim 8, wherein:
said device further comprises two remote control units, a first remote control unit corresponding to said standard operating mode and a second remote control unit corresponding to said increased accessibility mode; and
said device will change operating mode in accordance with which remote control unit last transmitted a control signal to said device.

10. The device of claim 9, wherein said remote control units are distinguished by an electronic identifier appended to an output control signal.

11. The device of claim 9, wherein said remote control units are distinguished by different coding protocols for said control signal.

12. The device of claim 1, further comprising a mechanical switch for switching between said standard operating mode and said increased accessibility mode.

13. The device of claim 1, wherein said increased accessibility mode applies only to settings for a specified one or more of said number of features.

14. A method of making an electronic device that comprises a number of features for which settings can be adjusted by a user, said method comprising;
making a user interface through which said user can adjust said settings;
defining a standard operating mode in which settings for all of said features are available through said user interface, when activated; and
defining an increased accessibility operating mode in which settings for said features are presented differently in said user interface, when activated, than in said standard operating mode.

15. The method of claim 14, further comprising providing access to settings for less than all of said features in said user interface in said increased accessibility mode.

16. The method of claim 14, further comprising reordering access to settings for said features as presented in said standard operating mode when operating in said increased accessibility mode.

17. The method of claim 16, further comprising tracking which settings are most frequently adjusted by a user and reordering a listing of said settings in said user interface accordingly.

18. The method of claim 14, wherein said user interface comprises an on-screen display.

19. The method of claim 14, further comprising:
making two different remote control units, a first remote control unit corresponding to said standard operating mode and a second remote control unit corresponding to said increased accessibility mode; and
causing said device to change operating mode in accordance with which remote control unit last transmitted a control signal to said device.

20. The method of claim 14, further comprising installing a mechanical switch for switching between said standard operating mode and said increased accessibility mode.
